(19) United States
(12) Patent Application Publication
(10) Pub. No.: US 2026/0163660 A1
(43) Pub. Date: Jun. 11, 2026

(54) Measurements in a Communication Network

(71) Applicant: Telefonaktiebolaget LM Ericsson (publ), Stockholm (SE)

(72) Inventors: Thomas Johansson, Åby (SE); Alberto Gonzalez Escudero, Linköping (SE)

(21) Appl. No.: 18/706,435

(22) PCT Filed: Nov. 1, 2022
(86) PCT No.: PCT/IB2022/060529

§ 371 Date: May 1, 2024

Related U.S. Application Data
(60) Provisional application No. 63/274,486, filed on Nov. 1, 2021.

(51) Int. Cl. H04B 17/318; H04W 72/0446; H04W 72/12

(52) U.S. Cl. CPC H04B 17/328; H04W 72/0446; H04W 72/12

(57) ABSTRACT

A user equipment, UE, (12) receives an indication (26) from a network (10) indicating from which symbol to start a measurement (20), out of multiple symbols (24) from which the measurement (20) can start. The measurement (20) may for example be a Received Signal Strength Indicator measurement or a Reference Signal Received Quality measurement. Regardless, the UE (12) performs the measurement (20) starting from the symbol indicated by the network (10). In some embodiments where the indication (26) indicates that the UE (12) is to start the measurement (20) from a symbol that is not the first symbol to occur in a slot (18), the CE (12) may transmit or receive data on one or more symbols that occur before the indicated symbol in the same slot (18).

### TECHNICAL FIELD

The present application relates generally to a communication network, and relates more particularly to measurements in such a network.

### BACKGROUND

A user equipment (UE) in a New Radio (NR) network performs a received signal strength indicator (RSSI) measurement, e.g., whenever a measurement that involves a serving cell measurement is configured. A UE may for example measure RSSI as the average of the total power (W) per Orthogonal Frequency Division Multiple Access (OFDMA) symbol over N resource blocks (RBs), where N is the number of resource blocks in the NR carrier RSSI measurement bandwidth.

Under some circumstances where the UE uses the first OFDMA symbol in one slot for the RSSI measurement, scheduling restrictions imposed for the UE mean that the UE cannot transmit or receive data on the last OFDMA symbol in the previous slot. In this case, it would not be possible to schedule data for the UE in two slots, even though a synchronization signal block (SSB) transmission on which the UE performs the RSSI measurement fits into one slot. With data restricted from being scheduled in two slots, rather than just one slot, data throughput suffers.

Scheduling restrictions imposed for the UE may also risk wasting resources and/or throughput degradation under some circumstances. For example, if the master node for dual connectivity operation configures the UE with intra-frequency measurements to monitor the quality of the primary secondary cell (SpCell), i.e., one or more secondary cell group (SCG) frequencies, the master node will impose scheduling restrictions on the UE so as not to schedule data for the UE when the UE is to perform the configured measurements. If the secondary node nonetheless unknowingly schedules data for the UE when the master node configured the UE to perform measurements, the resources on which the secondary node scheduled the data will go wasted rather than being used for other UEs. Worse, the resulting discontinuous transmission (DTX) can impact outer loop feedback, resulting in a faulty understanding of the link quality by the secondary node, reducing throughput further.

Similarly, in case of a split deployment whereby a gNB is split into a central unit (CU) and distributed unit(s), the CU heretofore only informs the DU(s) of UE measurements when gaps might be required for the measurements. In other scenarios, such as for intra-frequency measurements, then, where the CU does not inform the DU(s) of UE measurements, the DU(s) may neglect to apply the appropriate scheduling restrictions for the UE to perform the measurements. The result is that intra-frequency mobility between cells of DUs is only possible between overlapping beams in the two cells, or DTX is to be expected.

### SUMMARY

According to some embodiments herein, a measurement can start from any one of multiple symbols, e.g., in a slot configured for the measurement. The measurement may for instance be a Received Signal Strength Indicator (RSSI) measurement or a Reference Signal Received Quality (RSRQ) measurement. In one embodiment, rather than the measurement being able to start only from the first symbol in a slot, the measurement according to some embodiments herein can start from any one of multiple symbols, including a symbol that is not the first symbol in the slot. To support this, some embodiments herein introduce signaling for indicating to the UE from which symbol to start a measurement, e.g., out of multiple symbols from which the measurement can start. With the measurement being able to start from any one of multiple symbols, some embodiments enable the measurement to be started from a symbol that is not the first symbol in a slot. This advantageously means that data can be scheduled in the previous slot, improving data throughput as compared to if the measurement had to be started from the first symbol in the slot.

More particularly, embodiments herein include a method performed by a user equipment, UE. The method comprises receiving an indication from a network indicating from which symbol to start a measurement, out of multiple symbols from which the measurement can start. The measurement may for example be a Received Signal Strength Indicator (RSSI) measurement or a Reference Signal Received Quality (RSRQ) measurement. Regardless, the method in some embodiments also comprises performing the measurement starting from the symbol indicated by the network.

In some embodiments, the indication is a start symbol indication. In some embodiments, different values of the start symbol indication indicate different symbols from which the UE is to start the measurement. In some embodiments, the method further comprises receiving, from the network, an end symbol indication indicating at which symbol to end the measurement. In some embodiments, different values of the end symbol indication indicate different symbols at which the UE is to end the measurement. In some embodiments, the UE is to perform the measurement from the symbol indicated by the start symbol indication to the symbol indicated by the end symbol indication.

In some embodiments, the indication also indicates at which symbol to end the measurement, out of multiple symbols at which the measurement can end. In some embodiments, at least some different values of the indication are mapped to different ones of the multiple symbols from which the measurement can start, and at least some different values of the indication are mapped to different ones of the multiple symbols at which the measurement can end.

In some embodiments, the indication is an information element, IE. In some embodiments, different values of the IE are mapped to different sets of consecutive symbols on which to perform the measurement. In some embodiments, at least some of the different sets of consecutive symbols start the measurement on different symbols.

In some embodiments, the indication is a bit string, with different values of the bit string indicating different sets of symbols on which to perform the measurement. In some embodiments, at least some of the different sets of symbols start the measurement on different symbols.

In some embodiments, the UE is available for scheduling until 1 symbol before the symbol indicated by the indication.

In some embodiments, the UE is not expected to transmit or receive on 1 data symbol before the symbol indicated by the indication.

In some embodiments, the indication indicates that the UE is to start the measurement from a symbol that is not the first symbol to occur in a slot configured for the measurement. In some embodiments, performing the measurement comprises performing the measurement starting from the indicated symbol in a slot configured for the measurement, and the method further comprises transmitting or receiving data on one or more symbols that occur before the indicated symbol in the slot configured for the measurement.

In some embodiments, the indication indicates from which symbol, in a slot configured for the measurement, to start the measurement, out of multiple symbols from which the measurement can start in the slot.

Other embodiments herein include a method performed by a network node in a network. The method comprises transmitting, to a user equipment, UE, an indication indicating from which symbol to start a measurement, out of multiple symbols from which the measurement can start. The measurement may for example be a Received Signal Strength Indicator (RSSI) measurement or a Reference Signal Received Quality (RSRQ) measurement.

In some embodiments, the method also comprises scheduling the UE to transmit or receive data, accounting for the symbol from which the UE is to start the measurement.

In some embodiments, the indication is a start symbol indication. In some embodiments, different values of the start symbol indication indicate different symbols from which the UE is to start the measurement. In some embodiments, the method further comprises transmitting, to the UE, an end symbol indication indicating at which symbol to end the measurement. In some embodiments, different values of the end symbol indication indicate different symbols at which the UE is to end the measurement. In some embodiments, the UE is to perform the measurement from the symbol indicated by the start symbol indication to the symbol indicated by the end symbol indication.

In some embodiments, the indication also indicates at which symbol to end the measurement, out of multiple symbols at which the measurement can end. In some embodiments, at least some different values of the indication are mapped to different ones of the multiple symbols from which the measurement can start, and at least some different values of the indication are mapped to different ones of the multiple symbols at which the measurement can end.

In some embodiments, the indication is an information element, IE. In some embodiments, different values of the IE are mapped to different sets of consecutive symbols on which to perform the measurement. In some embodiments, at least some of the different sets of consecutive symbols start the measurement on different symbols.

In some embodiments, the indication is a bit string, with different values of the bit string indicating different sets of symbols on which to perform the measurement. In some embodiments, at least some of the different sets of symbols start the measurement on different symbols.

In some embodiments, the indication indicates that the UE is to start the measurement from a symbol that is not the first symbol to occur in a slot configured for the measurement. In some embodiments, the indication indicates from which symbol to start the measurement in a slot configured for the measurement, and the method further comprises scheduling the UE to transmit or receive data on one or more symbols that occur before the indicated symbol in the slot configured for the measurement.

In some embodiments, the indication indicates from which symbol, in a slot configured for the measurement, to start the measurement, out of multiple symbols from which the measurement can start in the slot.

Other embodiments herein include a user equipment, UE. The UE is configured to receive an indication from a network indicating from which symbol to start a measurement, out of multiple symbols from which the measurement can start. The measurement may for example be a Received Signal Strength Indicator (RSSI) measurement or a Reference Signal Received Quality (RSRQ) measurement. Regardless, the UE in some embodiments is also configured to perform the measurement starting from the symbol indicated by the network.

In some embodiments, the UE is configured to perform the steps described above for a UE.

Other embodiments herein include a network node configured for use in a network. The network node is configured to transmit, to a user equipment, UE, an indication indicating from which symbol to start a measurement, out of multiple symbols from which the measurement can start. The measurement may for example be a Received Signal Strength Indicator (RSSI) measurement or a Reference Signal Received Quality (RSRQ) measurement.

In some embodiments, the network node is configured to perform the steps described above for a network node in a network.

According to other embodiments herein, a network node can indicate to another network node scheduling restriction(s), e.g., due to intra-frequency measurement(s). In fact, the scheduling restriction(s) may be indicated on a frequency-by-frequency basis. For example, a master node can indicate such scheduling restriction(s) to a secondary node for dual connectivity operation, so that the secondary node can itself apply the scheduling restriction(s). As another example, a gNB central unit (CU) can indicate such scheduling restriction(s) to a gNB distributed unit (DU), so that the gNB DU can apply the scheduling restriction(s). Signaling scheduling restriction(s) between network nodes in this way may advantageously avoid resource waste, improve data throughput, enhance intra-frequency mobility between cells, and/or avoid discontinuous transmission (DTX).

In this regard, embodiments herein broadly include a method in a network node. The method comprises transmitting an indication to another network node indicating, for each of one or more frequencies, a scheduling restriction due to an intra-frequency measurement on that frequency.

In some embodiments, the indication is a list of one or more measurement timing information elements, IEs, for the one or more frequencies, respectively. In some embodiments, a measurement timing IE for a frequency indicates the scheduling restriction due to an intra-frequency measurement on that frequency. In some embodiments, an ss-RSSI-Measurement IE or an ssb-ToMeasure IE included in the measurement timing IE for a frequency indicates the scheduling restriction due to an intra-frequency measurement on that frequency.

In some embodiments, the indication is an intra-frequency scheduling restriction IE.

In some embodiments, the network node is a gNB or eNB master node, MN, and the another network node is an eNB or gNB secondary node, SN.

In some embodiments, the network node is a central unit of a radio network node, and the another network node is a distributed unit of the radio network node.

Other embodiments herein include a method in a network node. The method comprises receiving an indication from another network node indicating, for each of one or more frequencies, a scheduling restriction due to an intra-frequency measurement on that frequency.

In some embodiments, the indication is a list of one or more measurement timing information elements, IEs, for the one or more frequencies, respectively. In some embodiments, a measurement timing IE for a frequency indicates the scheduling restriction due to an intra-frequency measurement on that frequency. In some embodiments, an ss-RSSI-Measurement IE or an ssb-ToMeasure IE included in the measurement timing IE for a frequency indicates the scheduling restriction due to an intra-frequency measurement on that frequency.

In some embodiments, the indication is an intra-frequency scheduling restriction IE.

In some embodiments, the another network node is a gNB or eNB master node, MN, and the network node is an eNB or gNB secondary node, SN.

In some embodiments, the another network node is a central unit of a radio network node, and the network node is a distributed unit of the radio network node.

In some embodiments, the method further comprises scheduling the UE abiding by the scheduling restriction indicated for each of the one or more frequencies.

Other embodiments herein include a network node. The network node is configured to transmit an indication to another network node indicating, for each of one or more frequencies, a scheduling restriction due to an intra-frequency measurement on that frequency.

In some embodiments, the network node is configured to perform the steps described above for a network node.

Other embodiments herein include a network node. The network node is configured to receive an indication from another network node indicating, for each of one or more frequencies, a scheduling restriction due to an intra-frequency measurement on that frequency.

In some embodiments, the network node is configured to perform the steps described above for a network node.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a network and user equipment according to some embodiments.

FIG. 2 is a block diagram of a network that includes network nodes according to some embodiments.

FIG. 3 is a logic flow diagram of a method performed by a user equipment according to some embodiments.

FIG. 4 is a logic flow diagram of a method performed by a network node according to some embodiments.

FIG. 5 is a logic flow diagram of a method performed by a network node according to other embodiments.

FIG. 6 is a logic flow diagram of a method performed by a network node according to still other embodiments.

FIG. 7 is a block diagram of a user equipment according to some embodiments.

FIG. 8 is a block diagram of a network node according to some embodiments.

FIG. 9 is a block diagram of a communication system in accordance with some embodiments

FIG. 10 is a block diagram of a user equipment according to some embodiments.

FIG. 11 is a block diagram of a network node according to some embodiments.

FIG. 12 is a block diagram of a host according to some embodiments.

FIG. 13 is a block diagram of a virtualization environment according to some embodiments.

FIG. 14 is a block diagram of a host communicating via a network node with a UE over a partially wireless connection in accordance with some embodiments.

### DETAILED DESCRIPTION

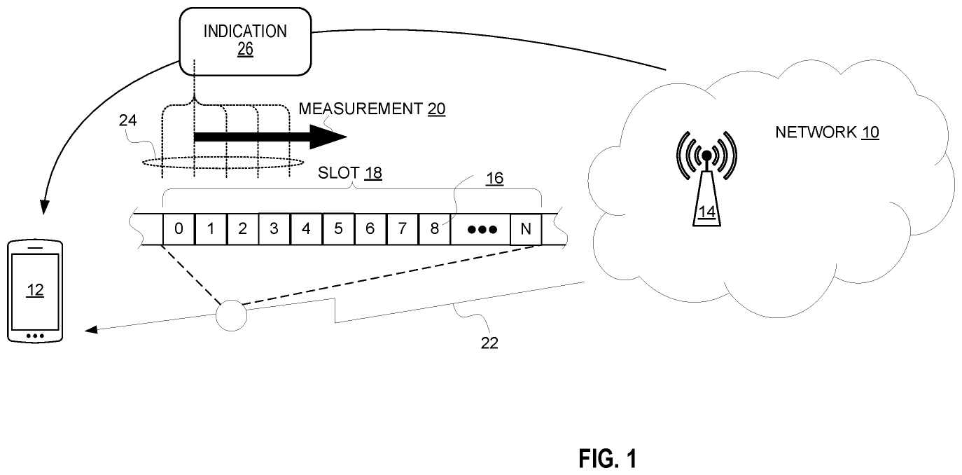

FIG. 1 shows a network 10 configured to serve a user equipment (UE) 12 according to some embodiments. The network 10 may for instance be a communication network, e.g., a 5G communication network, configured to provide communication service to the UE 12. In these and other embodiments, the network 10 may include a network node 14, e.g., a radio network node or gNB, configured to serve the UE 12.

As shown, transmissions in the network 10 are performed according to a transmission timing structure, whereby the transmissions are performed in structured time intervals. At one level of generality, transmissions are performed in time intervals that take the form of symbols 16. At another level of generality, transmissions are performed in time intervals that take the form of slots 18, where each slot 18 as shown includes N symbols 16.

In this context, the UE 12 as shown is configured to perform a measurement 20, e.g., on a transmission 22 that the network 10 transmits to the UE 12. The measurement 20 may for example be an intra-frequency measurement, a Received Signal Strength Indicator (RSSI) measurement, or a Reference Signal Received Quality (RSRQ) measurement. In these and other embodiments, the network 10 may configure the measurement 20, e.g., by sending the UE 12 a measurement configuration indicating one or more parameters according to which the UE 12 is to perform the measurement 20.

With transmissions in the network 10 performed in symbols 16, the UE 12 as shown is configured to perform the measurement 20 over one or more symbols 16. Where the measurement 20 is an RSSI measurement, for example, the UE 12 may be configured to measure the RSSI as the average of the total power (W) per symbol 16, over a certain number of symbols 16, e.g., starting from one symbol and ending at another symbol.

Notably, according to some embodiments herein, the measurement 20 can start from any one of multiple symbols 16, i.e., the measurement 20 is startable from any one of multiple symbols 16. That is, the measurement 20 is configurable to start from any one of multiple symbols 16, as opposed to always having to start from the same symbol 16. For example, in some embodiments, there are multiple symbols 16 from which the measurement 20 can start in a slot 18 configured for the measurement 20, as opposed to the measurement 20 always having to start from the same symbol (e.g., the first symbol 0) in the slot 18. As shown in FIG. 1, for instance, the measurement 20 can start from any one of multiple symbols 24 in a slot 18 configured for the measurement 20, e.g., where the multiple symbols 24 from which the measurement 20 can start in the slot 18 include symbols 0, 1, 2, 3, and 4, as opposed to the measurement 20 always having to start from symbol 0.

To support the measurement 20 being able to start from any of multiple symbols 16, e.g., in a slot 18, FIG. 1 shows that the network 10 transmits an indication 26 to the UE 12, e.g., in the form of an information element (IE), a bit string, etc. The indication 26 indicates from which symbol 16 to start the measurement 20, e.g., out of multiple symbols 24 from which the measurement 20 can start. For example, if the measurement 20 can start from any of symbols 0, 1, 2, 3, or 4 in the slot 18, the indication 26 indicates from which symbol to start the measurement 20, as between symbols 0, 1, 2, 3, or 4.

In some embodiments, the indication 26 is dedicated to indicating from which symbol 16 to start the measurement 20. For example, the indication 26 may be a start symbol indication, where different values of the start symbol indication indicate different symbols from which the UE 12 is to start the measurement 20, e.g., a value of 0 indicates to start the measurement 20 from symbol 0, a value of 1 indicates to start the measurement 20 from symbol 1, and so on. In these and other embodiments, then, the network 10 may transmit a separate indication to the UE 12 for indicating at which symbol 16 to end the measurement 20, e.g., where the UE 12 is to perform the measurement 20 starting from the symbol indicated by the start symbol indication to the symbol indicated by the end symbol indication. This separate indication may for example be an end symbol indication, where different values of the end symbol indication indicate different symbols at which the UE 12 is to end the measurement 20. Regardless, the symbol(s) on which the UE 12 performs the measurement 20 may accordingly include the start symbol, the end symbol, and any symbols between the start symbol and the end symbol.

In other embodiments not shown, the indication 26 not only indicates the symbol from which to start the measurement 20, but also indicates the symbol at which to end the measurement 20, e.g., out of multiple symbols at which the measurement 20 can end (i.e., the measurement 20 is endable on any one of multiple symbols). The indication 26 may for example jointly indicate the start symbol and the end symbol. In one embodiment, for instance, at least some different values of the indication 26 are mapped to different ones of the multiple symbols 24 from which the measurement 20 can start and/or at least some different values of the indication 26 are mapped to different ones of multiple symbols from which the measurement 20 can end. In one realization of this, different values of the indication 26 (e.g., IE or bit string) may be mapped to different sets of consecutive symbols on which to perform the measurement 20, with at least some of the different sets of consecutive symbols starting the measurement 20 on different symbols 16, e.g., a value of 0 indicates to perform the measurement on the set of symbols starting at symbol 0 and ending at symbol 7, a value of 1 indicates to perform the measurement on the set of symbols starting at symbol 1 and ending at symbol 8, etc.

No matter how the indication 26 indicates the symbol from which to start the measurement 20, with the measurement 20 being able to start from any one of multiple symbols, some embodiments enable the measurement 20 to be started from a symbol that is not the first symbol in a slot 18. This proves advantageous in some embodiments where data is restricted from being scheduled in the 1 symbol before the symbol from which the measurement 20 starts, i.e., the measurement start symbol. Indeed, if the measurement start symbol is not the first symbol in a slot 18, the symbol before the measurement start symbol necessarily occurs in the same slot as the measurement start symbol, rather than spilling over into the previous slot. This means that data can be scheduled in the previous slot, advantageously improving data throughput as compared to if the measurement start symbol were the first symbol in the slot 18. Accordingly, in some embodiments, the UE 12 performs the measurement 20 starting from a symbol that is not the first symbol in a slot 18 configured for the measurement 20, and furthermore transmits or receives data on symbol(s) that occur before the measurement start symbol in that same slot 18.

Consider an example of some of these embodiments as applicable to RSSI measurements in the following context. In this example, a Reference Signal Received Quality (RSRQ) measurement is defined as RSRQ=N*RSRP/RSSI, e.g., according to the 3rd Generation Partnership Project (3GPP) Technical Specification (TS) 38.215, NR; Physical layer measurements V16.4.0 (2020 December) (hereinafter referred to as “3GPP TS 38.215” or “TS 38.215”; the entire contents of which are incorporated by reference herein for all purposes). Here N is the number of resource blocks in the NR (New Radio) carrier RSSI (Received Signal Strength Indicator) measurement bandwidth. RSRP (reference signal received power) is the average power of RBs (resource blocks) carrying a Secondary Synchronization Signal (SSS) during SMTC (Synchronization Signal Block (SSB) Measurement Timing Configuration), where noise and interference are not part of the measurement. RSSI is the average of total power (W) per OFDMA (orthogonal frequency-division multiple access) symbol over N RBs.

Heretofore, all OFDMA symbols in a slot or those indicated by endSymbol (3GPP TS 38.215, 0 {0-1}, 1 {0-11}, 2 {0-5}, 3 {0-7}) were used for RSSI measurement.

| OFDM signal indication | Symbol |
|---|---|
| endSymbol | indexes |
| 0 | {0, 1} |
| 1 | {0, 1, 2, . . . , 10, 11} |
| 2 | {0, 1, 2, . . . , 5} |
| 3 | {0, 1, 2, . . . , 7} |

### 3GPP TS 38.215 V16.4.0 Table 5.1.3-1: NR Carrier RSSI Measurement Symbols

As observed, then, symbol 0 was heretofore always used when measuring RSSI (and RSRQ), as the only thing actually indicated by endSymbol is the symbol at which to end the measurement.

By contrast, in one embodiment herein, the UE receives an indication from the network indicating from which symbol to start the RSSI measurement. Upon reception of the new indication, the UE is available for scheduling until 1 symbol before the symbols indicated by the network. The UE may accordingly perform an RSSI measurement starting from symbols indicated by the network.

Consider now a specific example implementation of such an indication. In one embodiment, the indication is included in an SS-RSSI-Measurement information element (IE) as shown below:

| -- ASN1START | |
|---|---|
| -- TAG-SS-RSSI-MEASUREMENT-START | |
| SS-RSSI-Measurement ::= | SEQUENCE { |
| measurementSlots | BIT STRING (SIZE (1..80)), |
| endSymbol | INTEGER(0..3) |
| startSymbol | INTEGER(0..10} OPTIONAL |

}
-- TAG-SS-RSSI-MEASUREMENT-STOP
-- ASN1STOP

Here, the startSymbol is an optional IE whose value (0-10) indicates the index of the symbol from which to start an RSSI measurement in a slot configured for the RSSI measurement, e.g., where different values of startSymbol are mapped in a table to different symbol indices. Within a slot that is configured for RSSI measurements, the UE measures the RSSI from symbol startSymbol to symbol endSymbol.

In some embodiments, measurementSlots indicates the slots in which the UE can perform RSSI measurements. The length of the BIT STRING is equal to the number of slots in the configured SMTC window (determined by the duration and by the subcarrierSpacing). The first (left-most/most significant) bit in the bitmap corresponds to the first slot in the SMTC window, the second bit in the bitmap corresponds to the second slot in the SMTC window, and so on. The UE measures in slots for which the corresponding bit in the bitmap is set to 1. In case this field is configured for a SCell with ca-SlotOffset-r16, the bits in the bitmap correspond to the slots that are fully contained in the SMTC window.

As an alternative example implementation, additional endSymbol configurations are introduced to provide start symbol flexibility. In an exemplary case:

NR Carrier RSSI measurement symbols

| OFDM signal indication | Symbol |
|---|---|
| endSymbol | indexes |
| 0 | {0, 1} |
| 1 | {0, 1, 2, . . . , 10, 11} |
| 2 | {0, 1, 2, . . . , 5} |
| 3 | {0, 1, 2, . . . , 7} |
| 4 | {1, 2, . . . , 10, 11} |
| 5 | {1, 2, . . . , 5} |
| 6 | {1, 2, . . . , 7} |

Here, the endSymbol IE jointly indicates both (i) the symbol from which to start an RSSI measurement, out of symbols from which the RSSI measurement can start (namely, symbols 0 and 1); and (ii) the symbol at which to end the RSSI measurement, out of symbols at which the RSSI measurement can end (namely, symbols 1, 5, 7, and 11).

As yet another alternative, the indication can be implemented as a bit string indicating the specific symbols on which to measure.

In one embodiment, the indication can be added as a separate information element (IE) outside of SS-RSSI-Measurement.

In some embodiments, the indication of from which symbol to start a measurement is provided in a context where scheduling restrictions are applicable, as described below.

In some embodiments, for example, the following restrictions apply for intra-frequency measurements, e.g., according to 3GPP TS 38.133 NR; Requirements for support of radio resource management V17.2.0 (2021 June) (hereinafter referred to as “3GPP TS 38.133” or “TS 38.133”; the entire contents of which are incorporated by reference herein for all purposes).

In one embodiment, the following scheduling restriction applies due to Synchronization Signal (SS)-RSRP or SS-SINR (Signal-to-Interference-plus-Noise Ratio) measurement on an FR2 intra-frequency cell: The UE is not expected to transmit PUCCH/PUSCH/SRS or receive PDCCH/PDSCH/TRS/CSI-RS for CQI on SSB symbols to be measured, and on 1 data symbol before each consecutive SSB symbol to be measured and 1 data symbol after each consecutive SSB symbol to be measured within SMTC window duration. Here, PUCCH stands for Physical Uplink Control Channel, PUSCH stands for Physical Uplink Shared Channel, SRS stands for Sounding Reference Signal, PDCCH stands for Physical Downlink Control Channel, PDSCH stands for Physical Downlink Shared Chanel, TRS stands for Tracking Reference Signal, CSI-RS stands for Channel State Information Reference Signal, and CQI stands for Channel Quality Indicator.

In another embodiment, the following scheduling restriction applies to SS-RSRQ measurement on an FR2 intra-frequency cell: The UE is not expected to transmit PUCCH/PUSCH/SRS or receive PDCCH/PDSCH/TRS/CSI-RS for CQI on SSB symbols to be measured, RSSI measurement symbols, and on 1 data symbol before each consecutive SSB symbol to be measured/RSSI symbols and 1 data symbol after each consecutive SSB symbol to be measured/RSSI symbols within SMTC window duration.

In yet another embodiment, when the UE performs intra-frequency measurements in a time division duplexing (TDD) band, the following restrictions apply due to SS-RSRP or SS-SINR measurement: The UE is not expected to transmit PUCCH/PUSCH/SRS on SSB symbols to be measured, and on 1 data symbol before each consecutive SSB symbol to be measured and 1 data symbol after each consecutive SSB symbol to be measured within SMTC window duration. And when the UE performs intra-frequency measurements in a TDD band, the following restrictions apply due to SS-RSRQ measurement: The UE is not expected to transmit PUCCH/PUSCH/SRS on SSB symbols to be measured, RSSI measurement symbols, and on 1 data symbol before each consecutive SSB symbol to be measured/RSSI symbols and 1 data symbol after each consecutive SSB symbol to be measured/RSSI symbols within SMTC window duration.

In this context, some embodiments that avoid always using symbol 0 for RSSI measurements in slots where RSSI measurements are performed advantageously make it possible to schedule a UE in the slot that occurs before the slot where SSB (Synchronization Signal Block) exists and where RSSI (and RSRQ) measurements are done. Such scheduling availability is applicable to intra-frequency measurements; that is, a serving cell has been configured for the UE on the frequency.

Some embodiments herein are applicable in a context in which serving cell RSRQ measurements always shall be measured when a measurement (measConfig) has been configured, e.g., according to 3GPP TS 38.331 NR; Radio Resource Control (RRC); Protocol specification v16.5.0 (2021 July) (hereinafter referred to as “3GPP TS 38.331” or “TS 38.331”; the entire contents of which are incorporated by reference herein for all purposes).

In particular, in some embodiments, an RRC_CONNECTED UE shall derive cell measurement results by measuring one or multiple beams associated per cell as configured by the network. For all cell measurement results, except for RSSI, and cross-link interference (CLI) measurement results in RRC_CONNECTED, the UE applies layer 3 filtering before using the measured results for evaluation of reporting criteria, measurement reporting or the criteria to trigger conditional reconfiguration execution. For cell measurements, the network can configure RSRP, RSRQ, SINR, received signal code power (RSCP) or EcNO as trigger quantity. For CLI measurements, the network can configure SRS-RSRP or CLI-RSSI as trigger quantity. For cell and beam measurements, reporting quantities can be any combination of quantities (i.e., only RSRP; only RSRQ; only SINR; RSRP and RSRQ; RSRP and SINR; RSRQ and SINR; RSRP, RSRQ and SINR; only RSCP; only EcNO; RSCP and EcNO), irrespective of the trigger quantity, and for CLI measurements, reporting quantities can be either SRS-RSRP or CLI-RSSI. For conditional reconfiguration execution, the network can configure up to 2 quantities, both using same RS type. The UE does not apply the layer 3 filtering to derive the channel busy ratio (CBR) measurements.

The network may also configure the UE to report measurement information per beam (which can either be measurement results per beam with respective beam identifier(s) or only beam identifier(s)). If beam measurement information is configured to be included in measurement reports, the UE applies the layer 3 beam filtering.

The UE shall, whenever the UE has a measConfig, perform RSRP and RSRQ measurements for each serving cell for which servingCellMO is configured as follows. If the reportConfig associated with at least one measld included in the measldList within VarMeasConfig contains an rsType set to ssb and ssb-ConfigMobility is configured in the measObject indicated by the servingCellMO, the UE shall derive serving cell measurement results based on SS/Physical Broadcast Channel (PBCH) block and, if the reportConfig associated with at least one measld included in the measldList within VarMeasConfig contains a reportQuantityRS-Indexes and maxNrofRS-IndexesToReport and contains an rsType set to ssb, the UE shall derive layer 3 filtered RSRP and RSRQ per beam for the serving cell based on SS/PBCH block.

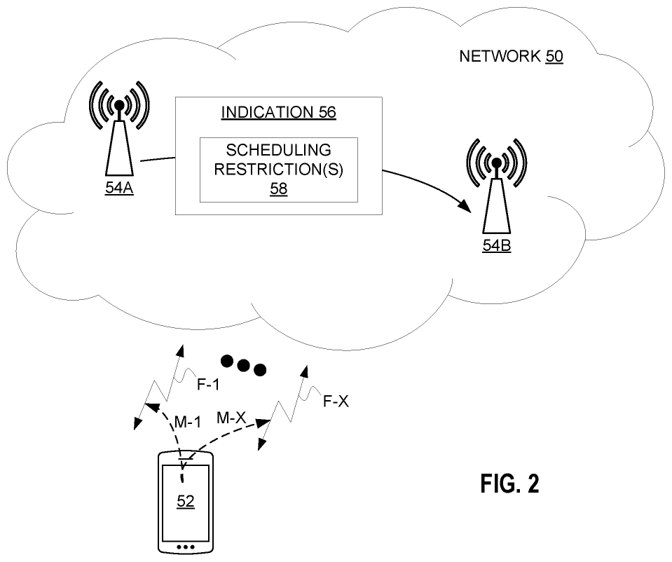

FIG. 2 illustrates other embodiments herein that may be implemented separately from or in combination with the embodiments described in FIG. 1. As shown in FIG. 2, a network 50 is configured to serve a user equipment (UE) 52. The network 50 may for instance be a communication network, e.g., a 5G communication network, configured to provide communication service to the UE 52. The network 50 includes network nodes 54A and 54B.

In some embodiments, the UE 52 operates in multi-connectivity operation. Multi-connectivity refers to the simultaneous connection of the UE 52 (e.g., at a radio resource control, RRC, layer) to multiple different radio network nodes, or to multiple different cells served by different radio network nodes. For example, in multi-connectivity, the UE 52 has multiple receivers (Rx) and/or transmitters (Tx) that utilize radio resources amongst one or more radio access technologies (e.g., New Radio, NR, and/or Evolved-UMTS (Universal Mobile Telecommunications System) Terrestrial Radio Access, E-UTRA) provided by multiple distinct schedulers connected via a non-ideal backhaul. Multi-radio dual connectivity (MR-DC) in this regard is a generalization of Intra-E-UTRA DC, where a multiple Rx/Tx wireless device may be configured to utilize resources provided by two different nodes connected via a non-ideal backhaul, one providing NR access and the other one providing either E-UTRA or NR access. One node acts as the master node (MN) and the other as the secondary node (SN). Evolved-UMTS Terrestrial Radio Access Network (E-UTRAN) for instance supports MR-DC via E-UTRA-NR dual connectivity (EN-DC), in which a wireless device is connected to one eNB that acts as a MN and one en-gNB that acts as a SN. Either way, in MR-DC, the UE 52 may have a single Radio Resource Control (RRC) state, based on the MN RRC and a single control plane connection towards the core network.

In one embodiment where the UE 52 operates in dual connectivity, network node 54A is master node (MN), e.g., an eNB or gNB MN, and network node 54B is a secondary node (SN), e.g., an eNB or gNB SN.

In other embodiments where the network 50 employs a split radio network node architecture, network node 54A may be a central unit (CU) of a radio network node and network node 54B may be a distributed unit (DU) of the radio network node.

Regardless, the network 50 configures the UE 52 in FIG. 2 to perform one or more intra-frequency measurements M1- . . . M-X on one or more frequencies F-1 . . . F-X. An intra-frequency measurement in this sense is a measurement on a frequency to which the UE 52 is tuned and/or operating on, i.e., the UE 52 need not re-tune to a different frequency to perform the measurement. In some embodiments, network node 54A (e.g., an MN or CU) configures the UE 52 in this regard to perform the one or more intra-frequency measurements M-1 . . . M-X. In these and other embodiments, the one or more frequencies F-1 . . . F-X may be one or more frequencies on which network node 54B serves the UE 52. For example, where network node 54B is a SN for dual connectivity, the one or more frequencies F-1 . . . F-X may be one or more secondary cell group (SCG) frequencies.

In this context, FIG. 2 shows that network node 54A transmits an indication 56 to network node 54B. For each of the one or more frequencies F-1 . . . F-X, the indication 56 indicates a scheduling restriction 58 due to an intra-frequency measurement on that frequency. A scheduling restriction 58 as used herein refers to a restriction on the scheduling of a data transmission to or from the UE 52. A scheduling restriction due to an intra-frequency measurement on a frequency therefore refers to a restriction on the scheduling of a data transmission on that frequency, where the restriction is attributable to an intra-frequency measurement being performed on the frequency, e.g., the UE 52 cannot simultaneously perform the intra-frequency measurement on the frequency and transmit or receive data on the frequency. In these and other embodiments, then, the indication 56 may take the form of an intra-frequency scheduling restriction IE.

Notably, the indication 56 indicates scheduling restriction(s) 58 on a frequency-by-frequency basis, e.g., each scheduling restriction 58 is frequency-specific. This contrasts with an inter-frequency measurement gap which applies generically across all frequencies.

In some embodiments, for example, the indication 56 is a list of one or more measurement timing IEs for the one or more frequencies F-1 . . . F-X, respectively, i.e., each measurement timing IE in the list is specific to a certain frequency. In this case, a measurement timing IE for a frequency indicates the scheduling restriction 58 due to an intra-frequency measurement on that frequency. For example, an ss-RSSI-Measurement IE or an ssb-ToMeasure IE included in the measurement timing IE for a frequency indicates the scheduling restriction due to an intra-frequency measurement on that frequency.

In any event, equipped with the indication 56, network node 54B advantageously schedules the UE 52, abiding by the scheduling restriction indicated for each of the one or more frequencies F-1 . . . F-X. For example, rather than naively scheduling the UE 52 on the one or more frequencies F-1 . . . F-X without knowledge of the scheduling restriction(s) 58 that are due to network node 54A configuring intra-frequency measurement(s) on the one or more frequencies F-1 . . . F-X, network node 54B may instead avoid scheduling the UE 52 on the one or more frequencies F-1 . . . F-X at times that would conflict with the intra-frequency measurement(s). This may in turn advantageously avoid resource waste, improve data throughput, enhance intra-frequency mobility between cells, and/or avoid discontinuous transmission (DTX).

Consider an example implementation where network node 54A is the MN in dual connectivity, network node 54B is the SN in dual connectivity, network node 54A configures the one or more intra-frequency measurements M-1 . . . M-X, and the one or more frequencies F-1 . . . F-X are one or more SCG frequencies. Where there are multiple intra-frequency measurement(s), then, the MN configures intra-frequency measurements on the secondary cell group (SCG) frequencies. In one example implementation in this context, the MN indicates the scheduling restriction(s) 58 to the SN by propagating the measurement configuration(s) (for the intra-frequency measurement(s) M-1 . . . M-X) to the SN, e.g., via cg-ConfigInfo.

In an exemplary embodiment, the indication 56 can be present as part of the IE MeasConfigMN, where the indication 56 in this example is the IntrafrequencyRestriction IE in the MeasConfigMN IE, with the scheduling restriction 58 for each frequency being the Meas TimingList provided for each frequency:

CG-ConfigInfo message

-- ASN1START
-- TAG-CG-CONFIG-INFO-START

| | |
|---|---|
| CG-ConfigInfo ::= | SEQUENCE { |
| criticalExtensions | CHOICE { |
| c1 | CHOICE{ |
| cg-ConfigInfo | CG-ConfigInfo-IEs, |
| spare3 | NULL, |
| spare2 | NULL, |
| spare1 | NULL |

},

| | |
|---|---|
| criticalExtensionsFuture | SEQUENCE { } |

}
}

| CG-ConfigInfo-IEs ::= | SEQUENCE { | |
|---|---|---|
| ue-CapabilityInfo | OCTET STRING (CONTAINING UE-CapabilityRAT-ContainerList) | |
| | | OPTIONAL, -- Cond SN-AddMod |
| candidateCellInfoListMN | MeasResultList2NR | OPTIONAL, |
| candidateCellInfoListSN | OCTET STRING (CONTAINING MeasResultList2NR) | OPTIONAL, |
| measResultCellListSFTD-NR | MeasResultCellListSFTD-NR | OPTIONAL, |

| | |
|---|---|
| scgFailureInfo | SEQUENCE { |
| failureType | ENUMERATED { t310-Expiry, randomAccessProblem, |
| | rlc-MaxNumRetx, synchReconfigFailure-SCG, |
| | scg-reconfigFailure, |
| | srb3-IntegrityFailure}, |
| measResultSCG | OCTET STRING (CONTAINING MeasResultSCG-Failure) |

} OPTIONAL,

| | | |
|---|---|---|
| configRestrictInfo | ConfigRestrictInfoSCG | OPTIONAL, |
| drx-InfoMCG | DRX-Info | OPTIONAL, |
| measConfigMN | MeasConfigMN | OPTIONAL, |
| sourceConfigSCG | OCTET STRING (CONTAINING RRCReconfiguration) | OPTIONAL, |
| scg-RB-Config | OCTET STRING (CONTAINING RadioBearerConfig) | OPTIONAL, |
| mcg-RB-Config | OCTET STRING (CONTAINING RadioBearerConfig) | OPTIONAL, |
| mrdc-AssistanceInfo | MRDC-AssistanceInfo | OPTIONAL, |
| nonCriticalExtension | CG-ConfigInfo-v1540-IEs | OPTIONAL |

}
MeasConfigMN ::= SEQUENCE {

| measuredFrequenciesMN | SEQUENCE (SIZE (1..maxMeasFreqsMN)) OF NR-FreqInfo | |
|---|---|---|
| | | OPTIONAL, |
| measGapConfig | SetupRelease { GapConfig } | OPTIONAL, |
| gapPurpose | ENUMERATED {perUE, perFR1} | OPTIONAL, |

```
  ...,
  [[
```

| | | |
|---|---|---|
| measGapConfigFR2 | SetupRelease { GapConfig } | OPTIONAL |

]]

| | |
|---|---|
| IntrafrequencyRestriction | MeasTimingList |

}

where Meas TimingList is defined in 3GPP TS 38.331 as:

MeasTimingList ::= SEQUENCE (SIZE (1..maxMeasFreqsMN)) OF MeasTiming
MeasTiming ::= SEQUENCE {

| frequencyAndTiming | SEQUENCE { | |
|---|---|---|
| carrierFreq | ARFCN-ValueNR, | |
| ssbSubcarrierSpacing | SubcarrierSpacing, | |
| ssb-MeasurementTimingConfiguration | SSB-MTC, | |
| ss-RSSI-Measurement | SS-RSSI-Measurement | OPTIONAL |

```
  } OPTIONAL,
  ...,
  [[
```

| | | |
|---|---|---|
| ssb-ToMeasure | SSB-ToMeasure | OPTIONAL, |
| physCellId | PhysCellId | OPTIONAL |

]]
}

The IE SSB-ToMeasure is used to configure a pattern of SSBs:

| | |
|---|---|
| SSB-ToMeasure ::= | CHOICE { |
| shortBitmap | BIT STRING (SIZE (4)), |
| mediumBitmap | BIT STRING (SIZE (8)), |
| longBitmap | BIT STRING (SIZE (64)) |

}

SSB-ToMeasure field descriptions

longBitmap
Bitmap when maximum number of SS/PBCH blocks per half frame equals to 64
mediumBitmap
Bitmap when maximum number of SS/PBCH blocks per half frame equals to 8 as defined in
TS 38.213, clause 4.1. For operation with shared spectrum channel access, if the k-th bit is
set to 1, the UE assumes that one or more SS/PBCH blocks within the SMTC measurement
duration with candidate SS/PBCH block indexes corresponding to SS/PBCH block index
equal to k − 1 may be transmitted; if the kt-th bit is set to 0, the UE assumes that the
corresponding SS/PBCH block(s) are not transmitted. The k-th bit is set to 0, where k > ssb-
PositionQCL-Common and the number of actually transmitted SS/PBCH blocks is not larger
than the number of 1's in the bitmap. If ssb-PositionQCL is configured with a value smaller
than ssb-PositionQCL-Common, only the leftmost K bits (K = ssb-PositionQCL) are applicable
for the corresponding cell.
shortBitmap
Bitmap when maximum number of SS/PBCH blocks per half frame equals to 4 as defined in
TS 38.213, clause 4.1.

Similarly, in the case of split gNB, the gNB-CU in some embodiments informs the gNB-DU when the gNB-CU configures intra-frequency measurement(s). In an exemplary embodiment, MeasTimingList is propagated for all intra-frequency measurements as part of CU 5 to DU RRC Information, in which case the indication scheduling restriction(s) 58 correspond to the MeasTimingList provided for each intra-frequency measurement:

CU to DU RRC Information

| IE/Group | | IE type and | | | Assigned |
|---|---|---|---|---|---|
| Name | Presence | reference | Semantics description | Criticality | Criticality |
| CG-ConfigInfo | O | OCTET | CG-ConfigInfo, as defined in | — | |
| | | STRING | TS 38.331. | | |
| UE- | O | OCTET | This IE is used in the NG- | — | |
| CapabilityRAT- | | STRING | RAN and it consists of the | | |
| ContainerList | | | UE-CapabilityRAT- | | |
| | | | ContainerList, as defined in | | |
| | | | TS 38.331. | | |
| MeasConfig | O | OCTET | MeasConfig, as defined in | — | |
| | | STRING | TS 38.331 (without | | |
| | | | MeasGapConfig). | | |
| | | | For EN-DC/NGEN-DC | | |
| | | | operation, includes the list of | | |
| | | | FR2 frequencies for which | | |
| | | | the gNB-CU requests the | | |
| | | | gNB-DU to generate gaps. | | |
| | | | For NG-RAN, NE-DC and MN | | |
| | | | for NR-NR DC, includes the | | |
| | | | list of FR1 and/or FR2 | | |
| | | | frequencies for which the | | |
| | | | gNB-CU requests the gNB- | | |
| | | | DU to generate gaps and the | | |
| | | | gap type (per-UE or per-FR). | | |
| Handover | O | OCTET | HandoverPreparationInformation, | YES | ignore |
| Preparation | | STRING | as defined in TS 38.331. | | |
| Information | | | | | |
| CellGroupConfig | O | OCTET | CellGroupConfig, as defined | YES | ignore |
| | | STRING | in TS 38.331. | | |
| Measurement | O | OCTET | Contains the | YES | ignore |
| Timing | | STRING | MeasurementTimingConfiguration | | |
| Configuration | | | inter-node message | | |
| | | | defined in TS 38.331. | | |
| | | | In EN-DC/NGEN-DC, it is | | |
| | | | included when the gaps for | | |
| | | | FR2 are requested to be | | |
| | | | configured by the MeNB. For | | |
| | | | MN in NR-NR DC, it is | | |
| | | | included when the gaps for | | |
| | | | FR2 and/or FR1 are | | |
| | | | requested by the SgNB | | |
| UEAssistanceInformation | O | OCTET | UEAssistanceInformation, as | YES | ignore |
| | | STRING | defined in TS 38.331. | | |
| CG-Config | O | OCTET | CG-Config, as defined in TS | YES | ignore |
| | | STRING | 38.331. | | |
| UEAssistanceInformationEUTRA | O | OCTET | UEAssistanceInformation, as | YES | ignore |
| | | STRING | defined in TS 36.331. | | |
| Intra- | O | OCTECT | MeasTimingList as defined | YES | ignore |
| Frequency | | STRING | in TS 38.331 with | | |
| scheduling | | | information of intra- | | |
| restrictions | | | frequency scheduling | | |
| | | | restrictions | | |

In these and other embodiments, in case of split deployment, the gNB-DU (5G Node B Distributed Unit) is not only informed of UE measurements when gaps might be required, but also when intra-frequency measurement(s) are configured.

Generally, then, some embodiments herein address challenges that exist when NR intra-frequency measurements, in some configurations, require scheduling restrictions. If nothing is specified, the restrictions apply during the whole SMTC duration. This is quite restrictive, as when many beams are transmitted, the SMTC duration can be 1 to 5 ms and have a high repetition rate, e.g., 20 ms. To mitigate the issue, it is possible to configure ssb-ToMeasure, to indicate to the UE which specific beams to measure for RSRP, and ss-RSSI-measurement, to indicate to the UE which slots to measure for RSRQ.

In some implementations, only SSB is transmitted during the SSB transmission slots. But since a UE must measure RSRQ and RSSI whenever a measurement that involves serving cell measurement is configured, a UE may not be available for scheduling in symbols where RSSI is to be measured. Some embodiments herein avoid the UE also being unavailable in the last symbol in the slot preceding that slot. Indeed, without support for mini-slots in NR, the scheduling is done on a slot level. This means that if any measurement is to be performed on a serving cell and mini-slots are not used, it would heretofore not be possible to schedule the UE in 2 slots per SSB transmission even though the SSB transmission fits into one slot. Some embodiments herein avoid this issue by allowing the measurement to start from a symbol that is not the first symbol in the slot.

Alternatively or additionally, some embodiments herein address a scenario in DC where it is possible that different vendors provide MN (master node) and SN (secondary node). In those cases, the MN might configure NR measurements to monitor the quality of the SpCell. This would result in scheduling restrictions, which the SN cannot heretofore be made aware of, as it is heretofore not possible to indicate the SN of the scheduling restrictions on the SpCell due to pCell configured measurements. If the SN is not aware of the scheduling restrictions, a UE might be scheduled but will not reply, and those scheduling resources could instead have been used for other UEs. On top of lost resources, the discontinuous transmission (DTX) can impact outer loop feedback, resulting in a faulty understanding of the link quality by the radio base station (RBS), reducing the throughput further.

Additionally, in cases where cells with different SSB patterns coexist in the same frequency, gNB-DU is heretofore not aware of the SSB pattern (or SMTC) configured; thus, it is heretofore not able to apply the scheduling restrictions. The result is that intra-frequency mobility is heretofore only possible between the overlapping beams in the two cells, or DTX is to be expected.

Some embodiments herein address such challenges by making the SN and/or gNB-DU aware of the scheduling restrictions, e.g., SSB pattern (or SMTC) configured.

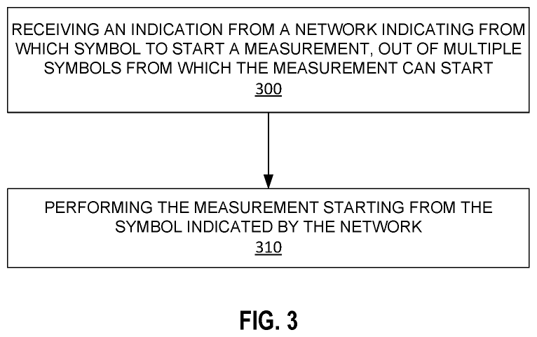

In view of the modifications and variations herein, FIG. 3 depicts a method performed by a user equipment (UE) 12 in accordance with particular embodiments. The method includes receiving an indication 26 from a network 10 indicating from which symbol to start a measurement 20 (e.g., an RSSI measurement or an RSRQ measurement) out of multiple symbols 24 from which the measurement 20 is can start (Block 300).

In some embodiments, the method also comprises performing the measurement 20 starting from the symbol indicated by the network 10 (Block 310).

In some embodiments, the indication 26 is a start symbol indication. In some embodiments, different values of the start symbol indication indicate different symbols from which the UE 12 is to start the measurement 20. In some embodiments, the method further comprises receiving, from the network 10, an end symbol indication indicating at which symbol to end the measurement 20. In some embodiments, different values of the end symbol indication indicate different symbols at which the UE 12 is to end the measurement 20. In some embodiments, the UE 12 is to perform the measurement 20 from the symbol indicated by the start symbol indication to the symbol indicated by the end symbol indication.

In some embodiments, the indication 26 also indicates at which symbol to end the measurement 20, out of multiple symbols at which the measurement 20 can end. In some embodiments, at least some different values of the indication 26 are mapped to different ones of the multiple symbols from which the measurement 20 can start, and at least some different values of the indication 26 are mapped to different ones of the multiple symbols at which the measurement 20 can end.

In some embodiments, the indication 26 is an information element, IE. In some embodiments, different values of the IE are mapped to different sets of consecutive symbols on which to perform the measurement 20. In some embodiments, at least some of the different sets of consecutive symbols start the measurement 20 on different symbols.

In some embodiments, the indication 26 is a bit string, with different values of the bit string indicating different sets of symbols on which to perform the measurement 20. In some embodiments, at least some of the different sets of symbols start the measurement 20 on different symbols.

In some embodiments, the UE 12 is available for scheduling until 1 symbol before the symbol indicated by the indication 26.

In some embodiments, the UE 12 is not expected to transmit or receive on 1 data symbol before the symbol indicated by the indication 26.

In some embodiments, the indication 26 indicates that the UE 12 is to start the measurement 20 from a symbol that is not the first symbol to occur in a slot 18 configured for the measurement 20. In some embodiments, performing the measurement 20 comprises performing the measurement 20 starting from the indicated symbol in a slot 18 configured for the measurement 20, and the method further comprises transmitting or receiving data on one or more symbols that occur before the indicated symbol in the slot 18 configured for the measurement 20.

In some embodiments, the indication 26 indicates from which symbol, in a slot 18 configured for the measurement 20, to start the measurement 20, out of multiple symbols from which the measurement 20 can start in the slot 18.

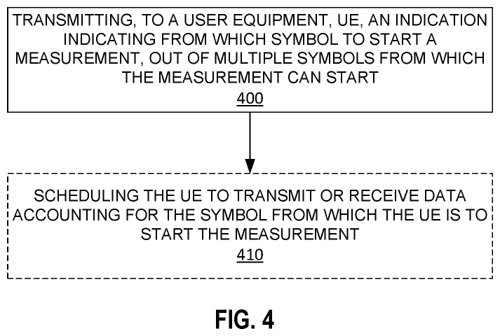

FIG. 4 depicts a method performed by a network node 14 in a network 10 in accordance with other particular embodiments. The method includes transmitting, to a user equipment (UE) 12 an indication 26 indicating from which symbol to start a measurement 20 (e.g., an RSSI measurement or an RSRQ measurement) out of multiple symbols 24 from which the measurement 20 can start (Block 400).

In some embodiments, the method also comprises scheduling the UE 12 to transmit or receive data, accounting for the symbol from which the UE 12 is to start the measurement 20 (Block 410). For example, where the indication 26 indicates from which symbol to start the measurement 20 in a slot 18 configured for the measurement 20, the network node 14 may schedule the UE 12 to transmit or receive data on one or more symbols that occur before the indicated symbol in the slot 18 configured for the measurement 20. If the symbol from which the UE 12 is to start the measurement 20 is not the first symbol to occur in the slot 18, this means that the network node 14 may schedule the UE 12 to transmit or receive data on one or more symbols that occur before the indicated symbol in the same slot 18 as that configured for the measurement 20.

In some embodiments, the indication 26 is a start symbol indication. In some embodiments, different values of the start symbol indication indicate different symbols from which the UE 12 is to start the measurement 20. In some embodiments, the method further comprises transmitting, to the UE 12, an end symbol indication indicating at which symbol to end the measurement 20. In some embodiments, different values of the end symbol indication indicate different symbols at which the UE 12 is to end the measurement 20. In some embodiments, the UE 12 is to perform the measurement 20 from the symbol indicated by the start symbol indication to the symbol indicated by the end symbol indication.

In some embodiments, the indication 26 also indicates at which symbol to end the measurement 20, out of multiple symbols at which the measurement 20 can end. In some embodiments, at least some different values of the indication 26 are mapped to different ones of the multiple symbols from which the measurement 20 can start, and at least some different values of the indication 26 are mapped to different ones of the multiple symbols at which the measurement 20 can end.

In some embodiments, the indication 26 is an information element, IE. In some embodiments, different values of the IE are mapped to different sets of consecutive symbols on which to perform the measurement 20. In some embodiments, at least some of the different sets of consecutive symbols start the measurement 20 on different symbols.

In some embodiments, the indication 26 is a bit string, with different values of the bit string indicating different sets of symbols on which to perform the measurement 20. In some embodiments, at least some of the different sets of symbols start the measurement 20 on different symbols.

In some embodiments, the indication 26 indicates that the UE 12 is to start the measurement 20 from a symbol that is not the first symbol to occur in a slot 18 configured for the measurement 20. In some embodiments, the indication 26 indicates from which symbol to start the measurement 20 in a slot 18 configured for the measurement 20, and the method further comprises scheduling the UE 12 to transmit or receive data on one or more symbols that occur before the indicated symbol in the slot 18 configured for the measurement 20.

In some embodiments, the indication 26 indicates from which symbol, in a slot 18 configured for the measurement 20, to start the measurement 20, out of multiple symbols from which the measurement 20 can start in the slot 18.

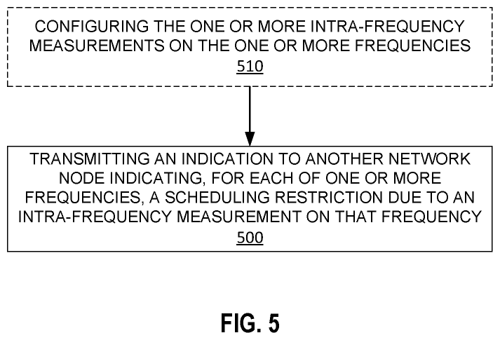

FIG. 5 depicts a method performed by a network node 54A in accordance with other particular embodiments. The method includes transmitting an indication 56 to another network node 54B indicating, for each of one or more frequencies F-1 . . . F-X, a scheduling restriction 58 due to an intra-frequency measurement M-1 . . . M-X on that frequency F-1 . . . F-X (Block 500).

In some embodiments, the method also comprises configuring the one or more intra-frequency measurements M-1 . . . M-X on the one or more frequencies F-1 . . . F-X (Block 510).

In some embodiments, the indication 56 is a list of one or more measurement timing information elements, IEs, for the one or more frequencies, respectively. In some embodiments, a measurement timing IE for a frequency indicates the scheduling restriction due to an intra-frequency measurement on that frequency. In some embodiments, an ss-RSSI-Measurement IE or an ssb-ToMeasure IE included in the measurement timing IE for a frequency indicates the scheduling restriction due to an intra-frequency measurement on that frequency.

In some embodiments, the indication 56 is an intra-frequency scheduling restriction IE.

In some embodiments, the network node 54A is a gNB or eNB master node, MN, and the another network node 54B is an eNB or gNB secondary node, SN.

In some embodiments, the network node 54A is a central unit of a radio network node, and the another network node 54B is a distributed unit of the radio network node.

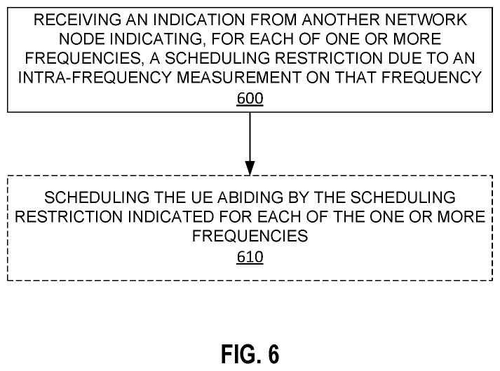

FIG. 6 depicts a method performed by a network node 54B in accordance with other particular embodiments. The method includes receiving an indication 56 from another network node 54A indicating, for each of one or more frequencies F-1 . . . F-X, a scheduling restriction 58 due to an intra-frequency measurement M-1 . . . M-X on that frequency F-1 . . . F-X (Block 600).

In some embodiments, the method further comprises scheduling the UE 52 abiding by the scheduling restriction 58 indicated for each of the one or more frequencies F-1 . . . F-X. (Block 610).

In some embodiments, the indication 56 is a list of one or more measurement timing information elements, IEs, for the one or more frequencies, respectively. In some embodiments, a measurement timing IE for a frequency indicates the scheduling restriction 58 due to an intra-frequency measurement on that frequency. In some embodiments, an ss-RSSI-Measurement IE or an ssb-ToMeasure IE included in the measurement timing IE for a frequency indicates the scheduling restriction 58 due to an intra-frequency measurement on that frequency.

In some embodiments, the indication 56 is an intra-frequency scheduling restriction IE.

In some embodiments, the another network node 54A is a gNB or eNB master node, MN, and the network node 54B is an eNB or gNB secondary node, SN.

In some embodiments, the another network node 54A is a central unit of a radio network node, and the network node 54B is a distributed unit of the radio network node.

Embodiments herein also include corresponding apparatuses. Embodiments herein for instance include a UE 12, 52 configured to perform any of the steps of any of the embodiments described above for the UE 12, 52.

Embodiments also include a UE 12, 52 comprising processing circuitry and power supply circuitry. The processing circuitry is configured to perform any of the steps of any of the embodiments described above for the UE 12, 52. The power supply circuitry is configured to supply power to the UE 12, 52.

Embodiments further include a UE 12, 52 comprising processing circuitry. The processing circuitry is configured to perform any of the steps of any of the embodiments described above for the UE 12, 52. In some embodiments, the UE 12, 52 further comprises communication circuitry.

Embodiments further include a UE 12, 52 comprising processing circuitry and memory. The memory contains instructions executable by the processing circuitry whereby the UE 12, 52 is configured to perform any of the steps of any of the embodiments described above for the UE 12, 52.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the UE 12, 52. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 14, 54A, 54B configured to perform any of the steps of any of the embodiments described above for the network node 14, 54A, 54B.

Embodiments also include a network node 14, 54A, 54B comprising processing circuitry and power supply circuitry. The processing circuitry is configured to perform any of the steps of any of the embodiments described above for the network node 14, 54A, 54B. The power supply circuitry is configured to supply power to the network node 14, 54A, 54B.

Embodiments further include a network node 14, 54A, 54B comprising processing circuitry. The processing circuitry is configured to perform any of the steps of any of the embodiments described above for the network node 14, 54A, 54B. In some embodiments, the network node 14, 54A, 54B further comprises communication circuitry.

Embodiments further include a network node 14, 54A, 54B comprising processing circuitry and memory. The memory contains instructions executable by the processing circuitry whereby the network node 14, 54A, 54B is configured to perform any of the steps of any of the embodiments described above for the network node 14, 54A, 54B.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

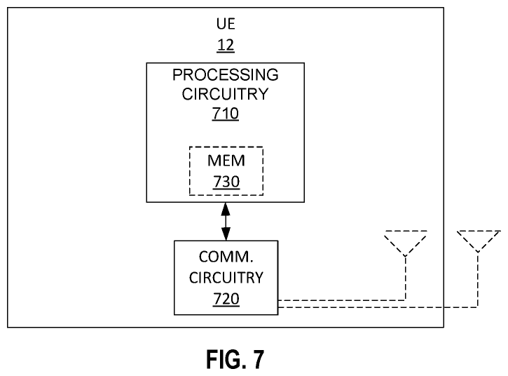

FIG. 7 for example illustrates a UE 12, 52 as implemented in accordance with one or more embodiments. As shown, the UE 12, 52 includes processing circuitry 710 and communication circuitry 720. The communication circuitry 720 (e.g., radio circuitry) is configured to transmit and/or receive information to and/or from one or more other nodes, e.g., via any communication technology. Such communication may occur via one or more antennas that are either internal or external to the UE 12, 52. The processing circuitry 710 is configured to perform processing described above, e.g., in FIG. 3, such as by executing instructions stored in memory 730. The processing circuitry 710 in this regard may implement certain functional means, units, or modules.

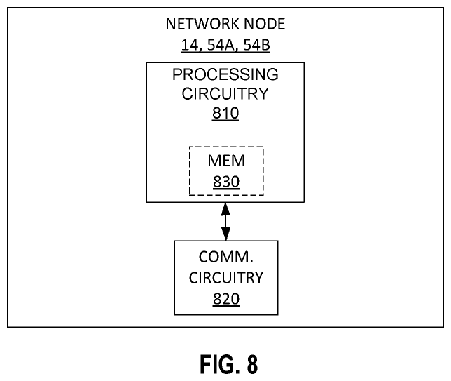

FIG. 8 illustrates a network node 14, 54A, 54B as implemented in accordance with one or more embodiments. As shown, the network node 14, 54A, 54B includes processing circuitry 810 and communication circuitry 820. The communication circuitry 820 is configured to transmit and/or receive information to and/or from one or more other nodes, e.g., via any communication technology. The processing circuitry 810 is configured to perform processing described above, e.g., in FIGS. 4, 5, and/or 6, such as by executing instructions stored in memory 830. The processing circuitry 810 in this regard may implement certain functional means, units, or modules.

Those skilled in the art will also appreciate that embodiments herein further include corresponding computer programs.

A computer program comprises instructions which, when executed on at least one processor of a UE 12, cause the UE 12 to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of a UE 12, cause the UE 12 to perform as described above.

Embodiments further include a computer program product comprising program code portions for performing the steps of any of the embodiments herein when the computer program product is executed by a UE 12. This computer program product may be stored on a computer readable recording medium.

A computer program comprises instructions which, when executed on at least one processor of a network node 14, 54A, 54B, cause the network node 14, 54A, 54B to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of a network node 14, 54A, 54B, cause the network node 14, 54A, 54B to perform as described above.

Embodiments further include a computer program product comprising program code portions for performing the steps of any of the embodiments herein when the computer program product is executed by a network node 14, 54A, 54B. This computer program product may be stored on a computer readable recording medium.

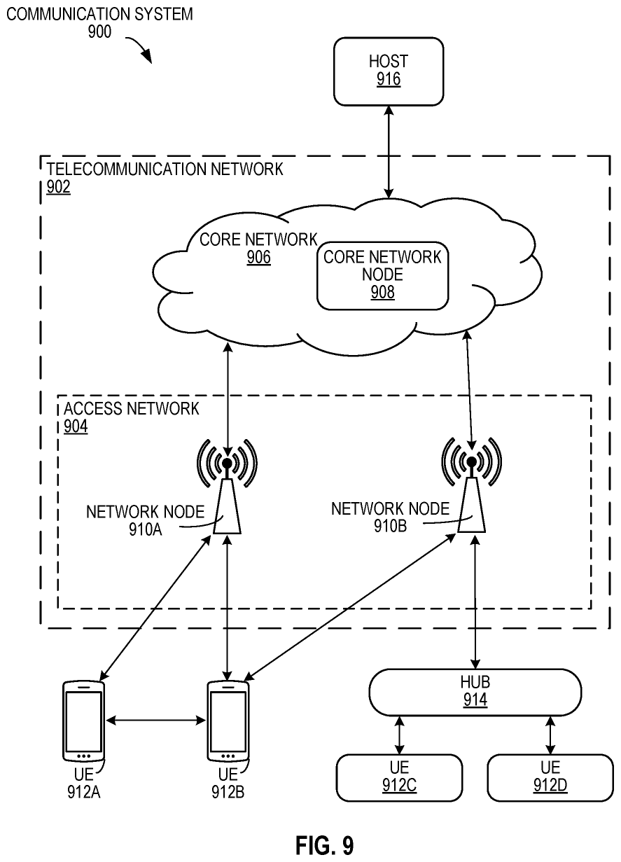

FIG. 9 shows an example of a communication system 900 in accordance with some embodiments.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3rd Generation Partnership Project (3GPP) access node or non-3GPP access point. The network nodes 910 facilitate direct or indirect connection of user equipment (UE), such as by connecting UEs 912a, 912b, 912c, and 912d (one or more of which may be generally referred to as UEs 912) to the core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910 and other communication devices. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as host 916. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 916 may be under the ownership or control of a service provider other than an operator or provider of the access network 904 and/or the telecommunication network 902, and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 914 communicates with the access network 904 to facilitate indirect communication between one or more UEs (e.g., UE 912c and/or 912d) and network nodes (e.g., network node 910b). In some examples, the hub 914 may be a controller, router, content source and analytics, or any of the other communication devices described herein regarding UEs. For example, the hub 914 may be a broadband router enabling access to the core network 906 for the UEs. As another example, the hub 914 may be a controller that sends commands or instructions to one or more actuators in the UEs. Commands or instructions may be received from the UEs, network nodes 910, or by executable code, script, process, or other instructions in the hub 914. As another example, the hub 914 may be a data collector that acts as temporary storage for UE data and, in some embodiments, may perform analysis or other processing of the data. As another example, the hub 914 may be a content source. For example, for a UE that is a VR headset, display, loudspeaker or other media delivery device, the hub 914 may retrieve VR assets, video, audio, or other media or data related to sensory information via a network node, which the hub 914 then provides to the UE either directly, after performing local processing, and/or after adding additional local content. In still another example, the hub 914 acts as a proxy server or orchestrator for the UEs, in particular in if one or more of the UEs are low energy IoT devices.

The hub 914 may have a constant/persistent or intermittent connection to the network node 910b. The hub 914 may also allow for a different communication scheme and/or schedule between the hub 914 and UEs (e.g., UE 912c and/or 912d), and between the hub 914 and the core network 906. In other examples, the hub 914 is connected to the core network 906 and/or one or more UEs via a wired connection. Moreover, the hub 914 may be configured to connect to an M2M service provider over the access network 904 and/or to another UE over a direct connection. In some scenarios, UEs may establish a wireless connection with the network nodes 910 while still connected via the hub 914 via a wired or wireless connection. In some embodiments, the hub 914 may be a dedicated hub—that is, a hub whose primary function is to route communications to/from the UEs from/to the network node 910b. In other embodiments, the hub 914 may be a non-dedicated hub—that is, a device which is capable of operating to route communications between the UEs and network node 910b, but which is additionally capable of operating as a communication start and/or end point for certain data channels.

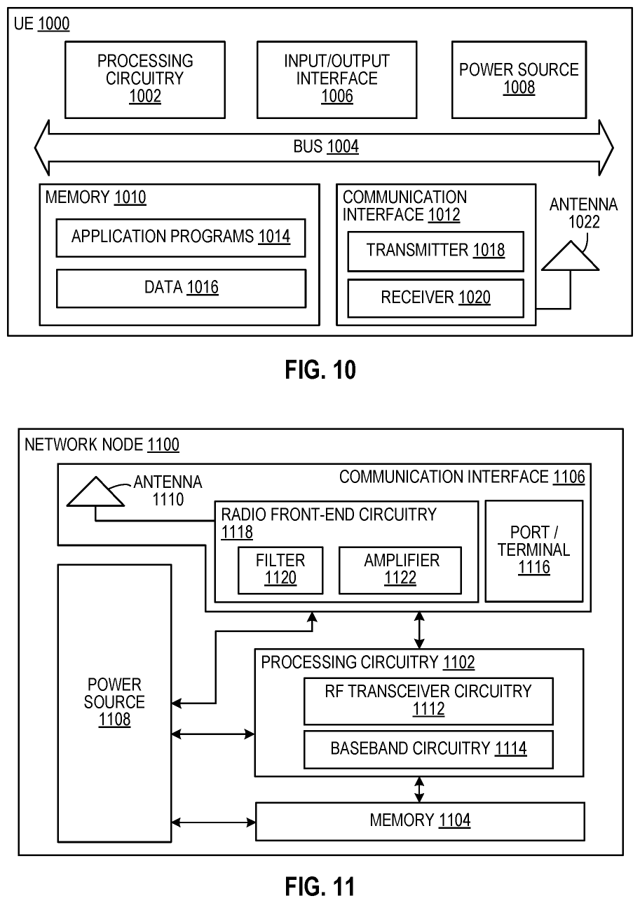

FIG. 10 shows a UE 1000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1000 includes processing circuitry 1002 that is operatively coupled via a bus 1004 to an input/output interface 1006, a power source 1008, a memory 1010, a communication interface 1012, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1002 is configured to process instructions and data and may be configured to implement any sequential state machine operative to execute instructions stored as machine-readable computer programs in the memory 1010. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1002 may include multiple central processing units (CPUs).

In the example, the input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1008 is structured as a battery or battery pack. Other types of power sources, such as an external power source (e.g., an electricity outlet), photovoltaic device, or power cell, may be used. The power source 1008 may further include power circuitry for delivering power from the power source 1008 itself, and/or an external power source, to the various parts of the UE 1000 via input circuitry or an interface such as an electrical power cable. Delivering power may be, for example, for charging of the power source 1008. Power circuitry may perform any formatting, converting, or other modification to the power from the power source 1008 to make the power suitable for the respective components of the UE 1000 to which power is supplied.

The memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1010 includes one or more application programs 1014, such as an operating system, web browser application, a widget, gadget engine, or other application, and corresponding data 1016. The memory 1010 may store, for use by the UE 1000, any of a variety of various operating systems or combinations of operating systems.

The memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1010 may allow the UE 1000 to access instructions, application programs and the like, stored on transitory or non-transitory memory media, to off-load data, or to upload data. An article of manufacture, such as one utilizing a communication system may be tangibly embodied as or in the memory 1010, which may be or comprise a device-readable storage medium.

The processing circuitry 1002 may be configured to communicate with an access network or other network using the communication interface 1012. The communication interface 1012 may comprise one or more communication subsystems and may include or be communicatively coupled to an antenna 1022. The communication interface 1012 may include one or more transceivers used to communicate, such as by communicating with one or more remote transceivers of another device capable of wireless communication (e.g., another UE or a network node in an access network). Each transceiver may include a transmitter 1018 and/or a receiver 1020 appropriate to provide network communications (e.g., optical, electrical, frequency allocations, and so forth). Moreover, the transmitter 1018 and receiver 1020 may be coupled to one or more antennas (e.g., antenna 1022) and may share circuit components, software or firmware, or alternatively be implemented separately.

In the illustrated embodiment, communication functions of the communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1000 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1100 includes a processing circuitry 1102, a memory 1104, a communication interface 1106, and a power source 1108. The network node 1100 may be composed of multiple physically separate components (e.g., a NodeB component and a RNC component, or a BTS component and a BSC component, etc.), which may each have their own respective components. In certain scenarios in which the network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). The network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

The processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as the memory 1104, to provide network node 1100 functionality.

In some embodiments, the processing circuitry 1102 includes a system on a chip (SOC). In some embodiments, the processing circuitry 1102 includes one or more of radio frequency (RF) transceiver circuitry 1112 and baseband processing circuitry 1114. In some embodiments, the radio frequency (RF) transceiver circuitry 1112 and the baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

The memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1102. The memory 1104 may store any suitable instructions, data, or information, including a computer program, software, an application including one or more of logic, rules, code, tables, and/or other instructions capable of being executed by the processing circuitry 1102 and utilized by the network node 1100. The memory 1104 may be used to store any calculations made by the processing circuitry 1102 and/or any data received via the communication interface 1106. In some embodiments, the processing circuitry 1102 and memory 1104 is integrated.

The communication interface 1106 is used in wired or wireless communication of signaling and/or data between a network node, access network, and/or UE. As illustrated, the communication interface 1106 comprises port(s)/terminal(s) 1116 to send and receive data, for example to and from a network over a wired connection. The communication interface 1106 also includes radio front-end circuitry 1118 that may be coupled to, or in certain embodiments a part of, the antenna 1110. Radio front-end circuitry 1118 comprises filters 1120 and amplifiers 1122. The radio front-end circuitry 1118 may be connected to an antenna 1110 and processing circuitry 1102. The radio front-end circuitry may be configured to condition signals communicated between antenna 1110 and processing circuitry 1102. The radio front-end circuitry 1118 may receive digital data that is to be sent out to other network nodes or UEs via a wireless connection. The radio front-end circuitry 1118 may convert the digital data into a radio signal having the appropriate channel and bandwidth parameters using a combination of filters 1120 and/or amplifiers 1122. The radio signal may then be transmitted via the antenna 1110. Similarly, when receiving data, the antenna 1110 may collect radio signals which are then converted into digital data by the radio front-end circuitry 1118. The digital data may be passed to the processing circuitry 1102. In other embodiments, the communication interface may comprise different components and/or different combinations of components.

In certain alternative embodiments, the network node 1100 does not include separate radio front-end circuitry 1118, instead, the processing circuitry 1102 includes radio front-end circuitry and is connected to the antenna 1110. Similarly, in some embodiments, all or some of the RF transceiver circuitry 1112 is part of the communication interface 1106. In still other embodiments, the communication interface 1106 includes one or more ports or terminals 1116, the radio front-end circuitry 1118, and the RF transceiver circuitry 1112, as part of a radio unit (not shown), and the communication interface 1106 communicates with the baseband processing circuitry 1114, which is part of a digital unit (not shown).

The antenna 1110 may include one or more antennas, or antenna arrays, configured to send and/or receive wireless signals. The antenna 1110 may be coupled to the radio front-end circuitry 1118 and may be any type of antenna capable of transmitting and receiving data and/or signals wirelessly. In certain embodiments, the antenna 1110 is separate from the network node 1100 and connectable to the network node 1100 through an interface or port.

The antenna 1110, communication interface 1106, and/or the processing circuitry 1102 may be configured to perform any receiving operations and/or certain obtaining operations described herein as being performed by the network node. Any information, data and/or signals may be received from a UE, another network node and/or any other network equipment. Similarly, the antenna 1110, the communication interface 1106, and/or the processing circuitry 1102 may be configured to perform any transmitting operations described herein as being performed by the network node. Any information, data and/or signals may be transmitted to a UE, another network node and/or any other network equipment.

The power source 1108 provides power to the various components of network node 1100 in a form suitable for the respective components (e.g., at a voltage and current level needed for each respective component). The power source 1108 may further comprise, or be coupled to, power management circuitry to supply the components of the network node 1100 with power for performing the functionality described herein. For example, the network node 1100 may be connectable to an external power source (e.g., the power grid, an electricity outlet) via an input circuitry or interface such as an electrical cable, whereby the external power source supplies power to power circuitry of the power source 1108. As a further example, the power source 1108 may comprise a source of power in the form of a battery or battery pack which is connected to, or integrated in, power circuitry. The battery may provide backup power should the external power source fail.

Embodiments of the network node 1100 may include additional components beyond those shown in FIG. 11 for providing certain aspects of the network node's functionality, including any of the functionality described herein and/or any functionality necessary to support the subject matter described herein. For example, the network node 1100 may include user interface equipment to allow input of information into the network node 1100 and to allow output of information from the network node 1100. This may allow a user to perform diagnostic, maintenance, repair, and other administrative functions for the network node 1100.

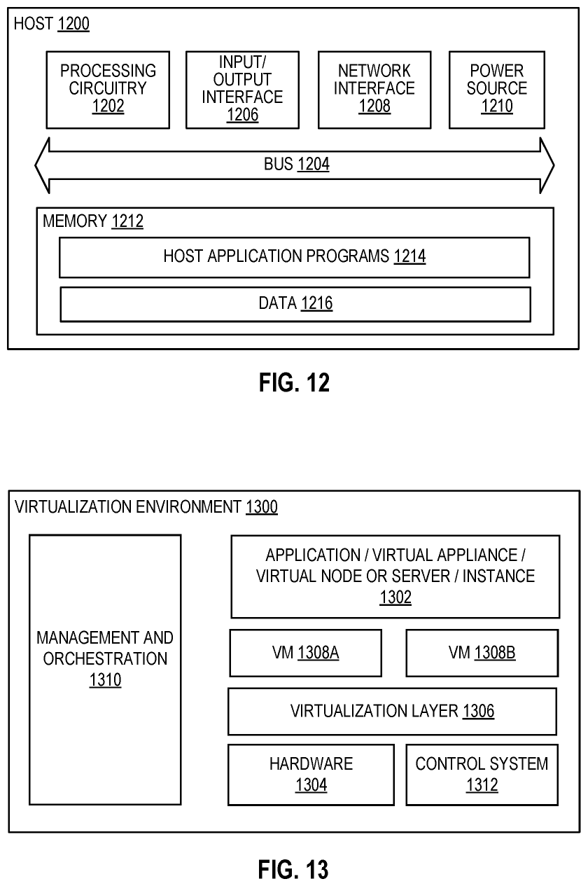

FIG. 12 is a block diagram of a host 1200, which may be an embodiment of the host 916 of FIG. 9, in accordance with various aspects described herein. As used herein, the host 1200 may be or comprise various combinations hardware and/or software, including a standalone server, a blade server, a cloud-implemented server, a distributed server, a virtual machine, container, or processing resources in a server farm. The host 1200 may provide one or more services to one or more UEs.

The host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

The memory 1212 may include one or more computer programs including one or more host application programs 1214 and data 1216, which may include user data, e.g., data generated by a UE for the host 1200 or data generated by the host 1200 for a UE. Embodiments of the host 1200 may utilize only a subset or all of the components shown. The host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1214 may also provide for user authentication and licensing checks and may periodically report health, routes, and content availability to a central node, such as a device in or on the edge of a core network. Accordingly, the host 1200 may select and/or indicate a different host for over-the-top services for a UE. The host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a and 1308b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

The VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1308 may be a software implementation of a physical machine that runs programs as if they were executing on a physical, non-virtualized machine. Each of the VMs 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of the hardware 1304 and corresponds to the application 1302.

Hardware 1304 may be implemented in a standalone network node with generic or specific components. Hardware 1304 may implement some functions via virtualization. Alternatively, hardware 1304 may be part of a larger cluster of hardware (e.g. such as in a data center or CPE) where many hardware nodes work together and are managed via management and orchestration 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

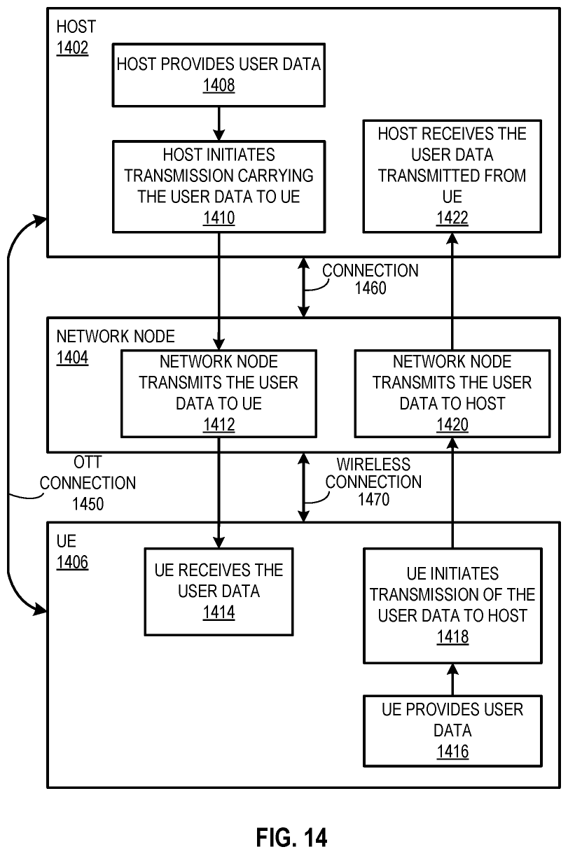

FIG. 14 shows a communication diagram of a host 1402 communicating via a network node 1404 with a UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. The host 1402 also includes software, which is stored in or accessible by the host 1402 and executable by the processing circuitry. The software includes a host application that may be operable to provide a service to a remote user, such as the UE 1406 connecting via an over-the-top (OTT) connection 1450 extending between the UE 1406 and host 1402. In providing the service to the remote user, a host application may provide user data which is transmitted using the OTT connection 1450.

The network node 1404 includes hardware enabling it to communicate with the host 1402 and UE 1406. The connection 1460 may be direct or pass through a core network (like core network 906 of FIG. 9) and/or one or more other intermediate networks, such as one or more public, private, or hosted networks. For example, an intermediate network may be a backbone network or the Internet.

The UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of the host 1402. In the host 1402, an executing host application may communicate with the executing client application via the OTT connection 1450 terminating at the UE 1406 and host 1402. In providing the service to the user, the UE's client application may receive request data from the host's host application and provide user data in response to the request data. The OTT connection 1450 may transfer both the request data and the user data. The UE's client application may interact with the user to generate the user data that it provides to the host application through the OTT connection 1450.

The OTT connection 1450 may extend via a connection 1460 between the host 1402 and the network node 1404 and via a wireless connection 1470 between the network node 1404 and the UE 1406 to provide the connection between the host 1402 and the UE 1406. The connection 1460 and wireless connection 1470, over which the OTT connection 1450 may be provided, have been drawn abstractly to illustrate the communication between the host 1402 and the UE 1406 via the network node 1404, without explicit reference to any intermediary devices and the precise routing of messages via these devices.

As an example of transmitting data via the OTT connection 1450, in step 1408, the host 1402 provides user data, which may be performed by executing a host application. In some embodiments, the user data is associated with a particular human user interacting with the UE 1406. In other embodiments, the user data is associated with a UE 1406 that shares data with the host 1402 without explicit human interaction. In step 1410, the host 1402 initiates a transmission carrying the user data towards the UE 1406. The host 1402 may initiate the transmission responsive to a request transmitted by the UE 1406. The request may be caused by human interaction with the UE 1406 or by operation of the client application executing on the UE 1406. The transmission may pass via the network node 1404, in accordance with the teachings of the embodiments described throughout this disclosure. Accordingly, in step 1412, the network node 1404 transmits to the UE 1406 the user data that was carried in the transmission that the host 1402 initiated, in accordance with the teachings of the embodiments described throughout this disclosure. In step 1414, the UE 1406 receives the user data carried in the transmission, which may be performed by a client application executed on the UE 1406 associated with the host application executed by the host 1402.

In some examples, the UE 1406 executes a client application which provides user data to the host 1402. The user data may be provided in reaction or response to the data received from the host 1402. Accordingly, in step 1416, the UE 1406 may provide user data, which may be performed by executing the client application. In providing the user data, the client application may further consider user input received from the user via an input/output interface of the UE 1406. Regardless of the specific manner in which the user data was provided, the UE 1406 initiates, in step 1418, transmission of the user data towards the host 1402 via the network node 1404. In step 1420, in accordance with the teachings of the embodiments described throughout this disclosure, the network node 1404 receives user data from the UE 1406 and initiates transmission of the received user data towards the host 1402. In step 1422, the host 1402 receives the user data carried in the transmission initiated by the UE 1406.

One or more of the various embodiments improve the performance of OTT services provided to the UE 1406 using the OTT connection 1450, in which the wireless connection 1470 forms the last segment. More precisely, the teachings of these embodiments may improve the throughput in the user equipment and/or in the cell and thereby provide benefits such as reduced user waiting time and/or better responsiveness that leads to better user experience.

In an example scenario, factory status information may be collected and analyzed by the host 1402. As another example, the host 1402 may process audio and video data which may have been retrieved from a UE for use in creating maps. As another example, the host 1402 may collect and analyze real-time data to assist in controlling vehicle congestion (e.g., controlling traffic lights). As another example, the host 1402 may store surveillance video uploaded by a UE. As another example, the host 1402 may store or control access to media content such as video, audio, VR or AR which it can broadcast, multicast or unicast to UEs. As other examples, the host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1450 between the host 1402 and UE 1406, in response to variations in the measurement results. The measurement procedure and/or the network functionality for reconfiguring the OTT connection may be implemented in software and hardware of the host 1402 and/or UE 1406. In some embodiments, sensors (not shown) may be deployed in or in association with other devices through which the OTT connection 1450 passes; the sensors may participate in the measurement procedure by supplying values of the monitored quantities exemplified above, or supplying values of other physical quantities from which software may compute or estimate the monitored quantities. The reconfiguring of the OTT connection 1450 may include message format, retransmission settings, preferred routing etc.; the reconfiguring need not directly alter the operation of the network node 1404. Such procedures and functionalities may be known and practiced in the art. In certain embodiments, measurements may involve proprietary UE signaling that facilitates measurements of throughput, propagation times, latency and the like, by the host 1402. The measurements may be implemented in that software causes messages to be transmitted, in particular empty or ‘dummy’ messages, using the OTT connection 1450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example embodiments of the techniques and apparatus described herein include, but are not limited to, the following enumerated examples:

### Group AA Embodiments

1. A method in a network node comprising:
   transmitting an indication to an evolved Node B (eNB) or gNB secondary node (SN) indicating scheduling restrictions.
2. The method of the previous embodiment, wherein the network node is a gNB or eNB master node (MN).
3. The method of any of the previous 2 embodiments, wherein the indication is one or more of:
   transmitted in an information element (IE) in XnAP, X2AP, and F1AP, that can be encoded in a radio resource control (RRC) container;
   a start symbol, Synchronization Signal Block (SSB) Measurement Timing Configuration (SMTC), ssb-ToMeasure, ss-RSSI-measurement, or similar IE conveying scheduling restriction information; or
   an interval of start and stop symbols and/or slots.

### Group A Embodiments

4. A method performed by a user equipment (UE) comprising:
   receiving an indication from a network indicating from which symbol to start a Received Signal Strength Indicator (RSSI) measurement; and
   performing RSSI measurement starting from symbols indicated by the network,
   wherein the UE is available for scheduling until 1 symbol before the new symbols indicated by the network.
5. The method of the previous embodiment, wherein the indication is one or more of: received on an information element (IE) on a radio resource control (RRC) layer, a start symbol, an interval of start and stop symbols, or a bit string indicating which symbols to measure.
6. The method of any of the previous embodiments, further comprising:
   providing user data; and
   forwarding the user data to a host via the transmission to the network node.

### Group B Embodiments

7. A method performed by a network node comprising:
   transmitting an indication to a user equipment (UE) indicating from which symbol to start a Received Signal Strength Indicator (RSSI) measurement.
8. The method of the previous embodiment, wherein the network node is a gNB.
9. The method of any of the previous 2 embodiments, wherein the indication is one or more of: transmitted on an information element (IE) on a radio resource control (RRC) layer, a start symbol, an interval of start and stop symbols, or a bit string indicating which symbols to measure.
10. The method of any of the previous embodiments, further comprising:
   obtaining user data; and
   forwarding the user data to a host or a user equipment.

### Group C Embodiments

11. A user equipment comprising:
   processing circuitry configured to perform any of the steps of any of the Group A embodiments; and
   power supply circuitry configured to supply power to the processing circuitry.
12. A network node comprising:
   processing circuitry configured to perform any of the steps of any of the Group B embodiments;
   power supply circuitry configured to supply power to the processing circuitry.
13. A user equipment (UE) comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
14. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
15. The host of the previous embodiment, wherein the cellular network further includes a network node configured to communicate with the UE to transmit the user data to the UE from the host.
16. The host of the previous 2 embodiments, wherein:
   the processing circuitry of the host is configured to execute a host application, thereby providing the user data; and
   the host application is configured to interact with a client application executing on the UE, the client application being associated with the host application.
17. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
18. The method of the previous embodiment, further comprising:
   at the host, executing a host application associated with a client application executing on the UE to receive the user data from the UE.
19. The method of the previous embodiment, further comprising:
   at the host, transmitting input data to the client application executing on the UE, the input data being provided by executing the host application,
   wherein the user data is provided by the client application in response to the input data from the host application.
20. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
21. The host of the previous embodiment, wherein the cellular network further includes a network node configured to communicate with the UE to transmit the user data from the UE to the host.
22. The host of the previous 2 embodiments, wherein:
   the processing circuitry of the host is configured to execute a host application, thereby providing the user data; and
   the host application is configured to interact with a client application executing on the UE, the client application being associated with the host application.
23. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
24. The method of the previous embodiment, further comprising:
   at the host, executing a host application associated with a client application executing on the UE to receive the user data from the UE.
25. The method of the previous embodiment, further comprising:
   at the host, transmitting input data to the client application executing on the UE, the input data being provided by executing the host application,
   wherein the user data is provided by the client application in response to the input data from the host application.
26. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
27. The host of the previous embodiment, wherein:
   the processing circuitry of the host is configured to execute a host application that provides the user data; and
   the UE comprises processing circuitry configured to execute a client application associated with the host application to receive the transmission of user data from the host.
28. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
29. The method of the previous embodiment, further comprising, at the network node, transmitting the user data provided by the host for the UE.
30. The method of any of the previous 2 embodiments, wherein the user data is provided at the host by executing a host application that interacts with a client application executing on the UE, the client application being associated with the host application.
31. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
32. The communication system of the previous embodiment, further comprising:
   the network node; and/or
   the user equipment.
33. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
34. The host of the previous 2 embodiments, wherein:
   the processing circuitry of the host is configured to execute a host application, thereby providing the user data; and
   the host application is configured to interact with a client application executing on the UE, the client application being associated with the host application.
35. The host of the any of the previous 2 embodiments, wherein the initiating receipt of the user data comprises requesting the user data.
36. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
37. The method of the previous embodiment, further comprising at the network node, transmitting the received user data to the host.

1.-49. (canceled)

50. A method performed by a user equipment (UE), the method comprising:
receiving an indication from a network indicating from which symbol to start a measurement, out of multiple symbols from which the measurement can start, wherein the measurement is a Received Signal Strength Indicator (RSSI) measurement or a Reference Signal Received Quality (RSRQ) measurement; and
performing the measurement starting from the symbol indicated by the network.

51. The method of claim 50, wherein the indication is a start symbol indication, wherein different values of the start symbol indication indicate different symbols from which the UE is to start the measurement.

52. The method of claim 51, wherein the method further comprises receiving, from the network, an end symbol indication indicating at which symbol to end the measurement, wherein different values of the end symbol indication indicate different symbols at which the UE is to end the measurement, wherein the UE is to perform the measurement from the symbol indicated by the start symbol indication to the symbol indicated by the end symbol indication.

53. The method of claim 50, wherein the indication also indicates at which symbol to end the measurement, out of multiple symbols at which the measurement can end, and wherein at least some different values of the indication are mapped to different ones of the multiple symbols from which the measurement can start, and wherein at least some different values of the indication are mapped to different ones of the multiple symbols at which the measurement can end.

54. The method of claim 50, wherein the indication is:
an information element (IE), wherein different values of the IE are mapped to different sets of consecutive symbols on which to perform the measurement, wherein at least some of the different sets of consecutive symbols start the measurement on different symbols; or
a bit string, with different values of the bit string indicating different sets of symbols on which to perform the measurement, wherein at least some of the different sets of symbols start the measurement on different symbols.

55. The method of claim 50, wherein the UE is available for scheduling until 1 symbol before the symbol indicated by the indication and/or the UE is not expected to transmit or receive on 1 data symbol before the symbol indicated by the indication.

56. The method of claim 50, wherein the indication indicates that the UE is to start the measurement from a symbol that is not the first symbol to occur in a slot configured for the measurement, and wherein performing the measurement comprises performing the measurement starting from the indicated symbol in a slot configured for the measurement, and wherein the method further comprises transmitting or receiving data on one or more symbols that occur before the indicated symbol in the slot configured for the measurement.

57. The method of claim 50, wherein the indication indicates from which symbol, in a slot configured for the measurement, to start the measurement, out of multiple symbols from which the measurement can start in the slot.

58. A method performed by a network node in a network, the method comprising:
transmitting, to a user equipment (UE), an indication indicating from which symbol to start a measurement, out of multiple symbols from which the measurement can start, wherein the measurement is a Received Signal Strength Indicator (RSSI) measurement or a Reference Signal Received Quality (RSRQ) measurement.

59. The method of claim 58, wherein the indication is a start symbol indication, wherein different values of the start symbol indication indicate different symbols from which the UE is to start the measurement.

60. The method of claim 58, further comprising scheduling the UE to transmit or receive data, accounting for the symbol from which the UE is to start the measurement.

61. A user equipment (UE) comprising:
communication circuitry; and
processing circuitry configured to:
receive an indication from a network indicating from which symbol to start a measurement, out of multiple symbols from which the measurement can start, wherein the measurement is a Received Signal Strength Indicator (RSSI) measurement or a Reference Signal Received Quality (RSRQ) measurement; and
perform the measurement starting from the symbol indicated by the network.

62. The UE of claim 61, wherein the indication is a start symbol indication, wherein different values of the start symbol indication indicate different symbols from which the UE is to start the measurement.

63. The UE of claim 62, wherein the processing circuitry is further configured to receive, from the network, an end symbol indication indicating at which symbol to end the measurement, wherein different values of the end symbol indication indicate different symbols at which the UE is to end the measurement, wherein the UE is to perform the measurement from the symbol indicated by the start symbol indication to the symbol indicated by the end symbol indication.

64. The UE of claim 61, wherein the indication also indicates at which symbol to end the measurement, out of multiple symbols at which the measurement can end, and wherein at least some different values of the indication are mapped to different ones of the multiple symbols from which the measurement can start, and wherein at least some different values of the indication are mapped to different ones of the multiple symbols at which the measurement can end.

65. The UE of claim 61, wherein the indication is:
an information element (IE), wherein different values of the IE are mapped to different sets of consecutive symbols on which to perform the measurement, wherein at least some of the different sets of consecutive symbols start the measurement on different symbols; or
a bit string, with different values of the bit string indicating different sets of symbols on which to perform the measurement, wherein at least some of the different sets of symbols start the measurement on different symbols.

66. The UE of claim 61, wherein the UE is available for scheduling until 1 symbol before the symbol indicated by the indication and/or the UE is not expected to transmit or receive on 1 data symbol before the symbol indicated by the indication.

67. The UE of claim 61, wherein the indication indicates that the UE is to start the measurement from a symbol that is not the first symbol to occur in a slot configured for the measurement, and wherein the processing circuitry is configured to perform the measurement starting from the indicated symbol in a slot configured for the measurement, and is further configured to transmit or receive data on one or more symbols that occur before the indicated symbol in the slot configured for the measurement.

68. The UE of claim 61, wherein the indication indicates from which symbol, in a slot configured for the measurement, to start the measurement, out of multiple symbols from which the measurement can start in the slot.

69. A network node configured for use in a network, the network node comprising:
communication circuitry; and
processing circuitry configured to transmit, to a user equipment (UE), an indication indicating from which symbol to start a measurement, out of multiple symbols from which the measurement can start, wherein the measurement is a Received Signal Strength Indicator (RSSI) measurement or a Reference Signal Received Quality (RSRQ) measurement.
